(19) United States
(12) Patent Application Publication
(10) Pub. No.: US 2022/0371463 A1
(43) Pub. Date: Nov. 24, 2022

(54) REMOVABLY ATTACHABLE VEHICLE BATTERY CHARGER

(71) Applicants: Rustee Stubbs, Washington, UT (US); Kenneth Miller, Washington, UT (US)

(72) Inventors: Rustee Stubbs, Washington, UT (US); Kenneth Miller, Washington, UT (US)

(21) Appl. No.: 17/746,717

(22) Filed: May 17, 2022

Related U.S. Application Data
(60) Provisional application No. 63/189,764, filed on May 18, 2021.

(51) Int. Cl. B60L 53/30; H02J 7/00; B60L 53/16

(52) U.S. Cl. CPC B60L 53/30; H02J 7/0013; B60L 53/16; B60L 53/35

(57) ABSTRACT

A removably attachable vehicle battery charger includes a housing having an engine (e.g., a high efficiency diesel engine) therein to charge a battery of an electric vehicle. The housing includes a tongue that may be received by a receiver hitch on the electric vehicle. The tongue may have charging components (e.g., wires and electrical contacts) that interact with electrical components (e.g., electrical contacts and wires) in the receiving hitch to provide charge to the batteries of the vehicle. The engine runs to charge the batteries of the electric vehicle, as needed or as programmed by a user.

### CROSS-REFERENCE TO RELATED APPLICATIONS

This application claims priority to U.S. Provisional Application Ser. No. 63/189,764, filed on May 18, 2021, which is incorporated herein by reference.

### TECHNICAL FIELD

The present disclosure relates to a vehicle battery charger. More particularly, the present disclosure relates to an electric vehicle battery charger that couples to an electric vehicle to extend its driving range.

### BACKGROUND

Electric vehicles have been used for decades. However, recently the popularity of electric vehicles has increased due to the rising concerns over fossil fuel sustainability and potential damage to the environment caused by fuel vehicles. Consequently, many vehicle manufacturers have turned their focus to manufacturing electric vehicles. These newly manufactured electric vehicles have many of the benefits that are found in vehicles using fossil fuels, such as similar design, comfort, and performance features.

In addition, electric vehicles have many benefits that fossil fuel vehicles do not have. For instance, electric vehicles are quiet while driving, are less expensive to drive, potentially cause less damage to the environment, and may be charged at many convenient locations, including a user's home. While there are many benefits to owning an electric vehicle, there are still many downsides. One of these downsides is the limited driving range on a full battery. Most driving ranges of electric vehicles are a fraction of the range that a fossil fuel vehicle can drive.

Typical electric vehicles require a battery recharge lasting 30 minutes for every 150 miles. If a user plans on using their electric vehicle within a few miles from home, then range is not as big of an issue. However, when a user needs to travel extended distances, issues may arise. For example, a user would have to charge the electric vehicle numerous times during an extended trip due to its limited driving range. Furthermore, even with the increase in the number of electric vehicles found in the country, there are still a limited number of charging stations, which may increase wait times to charge the vehicle. As a result, the traveling time to the destination increases significantly.

Further, if an electric vehicle is towing a trailer, the vehicle range decreases substantially and often makes it impossible for towing. For example, if a user desires to pull a trailer into the mountains for camping, the vehicle batteries may not hold a sufficient charge and, generally speaking, charging stations are not available in the mountains. As a result, the user would be stranded in the mountains. For this reason, electric vehicles are not usable for towing and mountain use.

Accordingly, there is a need for an apparatus and method that can increase the driving range of an electric vehicle and that can charge the electric vehicle from any location, including the mountains. The present disclosure seeks to solve these and other problems.

### SUMMARY OF EXAMPLE EMBODIMENTS

In one embodiment, a removably attachable vehicle battery charger comprises a housing with a lid hingedly coupled thereto. In some embodiments, the lid may be hingedly coupled to the housing. In some embodiments, the lid is place on the housing without the use of a hinge. A lock may secure the lid to the housing. The housing comprises a motor (e.g., a high efficiency diesel motor) and/or a battery to charge a battery of an electric vehicle. In addition, the housing comprises a housing hitch that may be received by a receiver hitch on the electric vehicle. The housing hitch may comprise charging components (e.g., power plug) that interact with electrical components (e.g., power socket) in the receiving hitch to provide charge to the battery of the vehicle.

In one embodiment, the removably attachable vehicle battery charger is positioned on a rack on a back of a camper trailer. Wire may be attached to the camper trailer so that the battery charger may charge the batteries of the camper trailer and/or the vehicle.

In one embodiment, the removably attachable vehicle battery charger is manufactured as part of a camper trailer, thereby acting as a generator for the camper trailer as well as for the electric vehicle.

### BRIEF DESCRIPTION OF THE DRAWINGS

FIG. 1 illustrates a side elevation view of an electric vehicle with a removably attachable vehicle battery charger coupled thereto;

FIG. 2 illustrates a side elevation view of an electric vehicle with a removably attachable vehicle battery charger detached therefrom;

FIG. 3 illustrates a diagram of a removably attachable vehicle battery charger;

FIG. 4 illustrates a side longitudinal cross-section of a receiver for use with a removably attachable vehicle battery charger;

FIG. 5 illustrates a side elevation view of a tongue of a removably attachable vehicle battery charger;

FIG. 6 illustrates a top view of a tongue of a removably attachable vehicle battery charger;

FIG. 7 illustrates a diagram of a removably attachable vehicle battery charger;

FIG. 8 illustrates a side elevation view of a removably attachable vehicle battery charger;

FIG. 9 illustrates a rear elevation view of a removably attachable vehicle battery charger;

FIG. 10 illustrates a side elevation view of a removably attachable vehicle battery charger;

FIG. 11 illustrates a side elevation view of a commercial truck with a removably attachable vehicle battery charger coupled thereto;

FIG. 12 illustrates a top plan view of a trailer with a removably attachable vehicle battery charger coupled thereto;

FIG. 13 illustrates a hitch system for a removably attachable vehicle battery charger;

FIG. 14 illustrates a hitch system for a removably attachable vehicle battery charger; and

FIG. 15 illustrates a user interface of a removably attachable vehicle battery charger.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need for an apparatus and method that can increase the driving range of an electric vehicle and that can charge the electric vehicle from any location, including the mountains, where grid electricity is not available or convenient. The removably attachable vehicle battery charger disclosed herein seeks to solve these and other problems.

In general, the removably attachable vehicle battery charger described herein remedies the aforementioned issue by utilizing combustion engine and/or battery that is coupled to a receiver hitch of the electric vehicle. In particular, the receiver hitch is wired to receive power from the removably attachable vehicle battery charger, thereby allowing the vehicle's battery to be charged while the vehicle is stationary or moving. It will be appreciated that the vehicle battery charger extends the range of an electric vehicle and may also be used to provide power to a house, camper, etc.

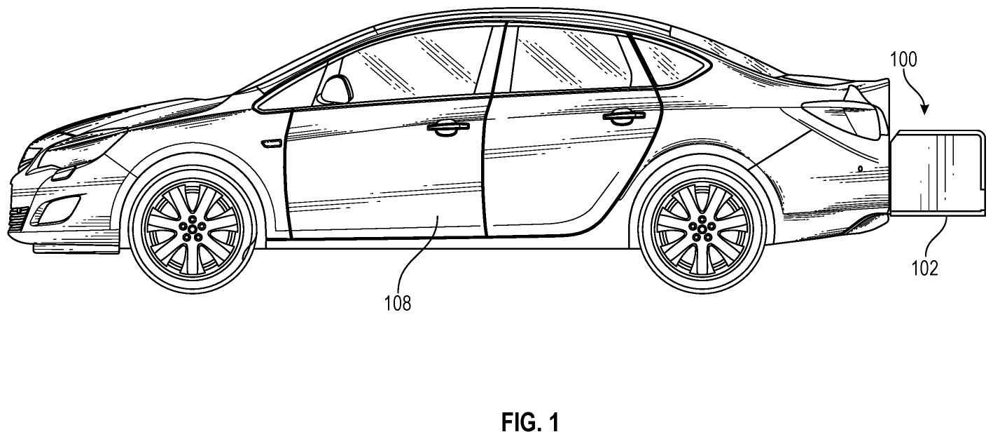

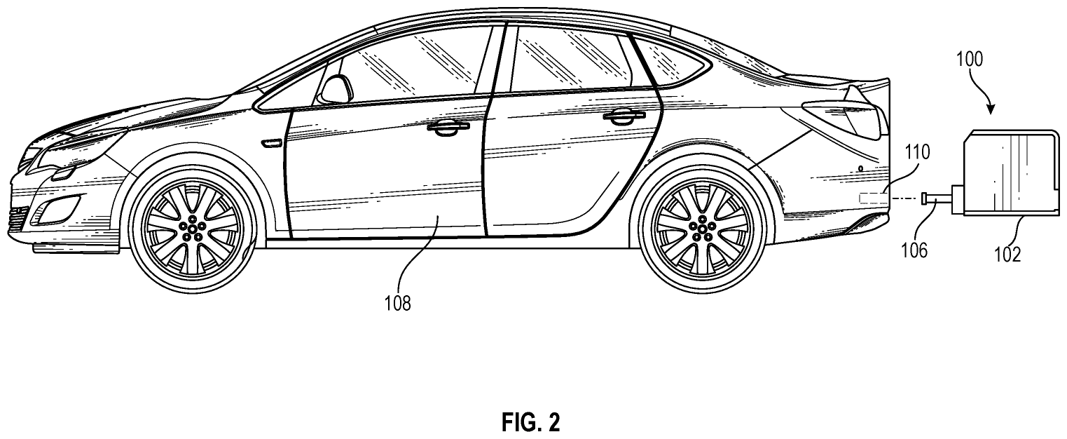

Referring to FIGS. 1-3, in one embodiment, a removably attachable vehicle battery charger 100 comprises a housing 102 having a combustion engine 104 therein and a tongue 106 for coupling to a vehicle 108. It will be appreciated that the housing 102 may be of any shape or size. For example, the housing 102 may be rectangular and compact so as to be easily coupled to an electric vehicle 108 without exceeding the approved weight of a hitch receiver 110 of the electric vehicle 108. In other words, the tongue 106 may be inserted into the hitch receiver 110 of a vehicle 108 so as to couple thereto.

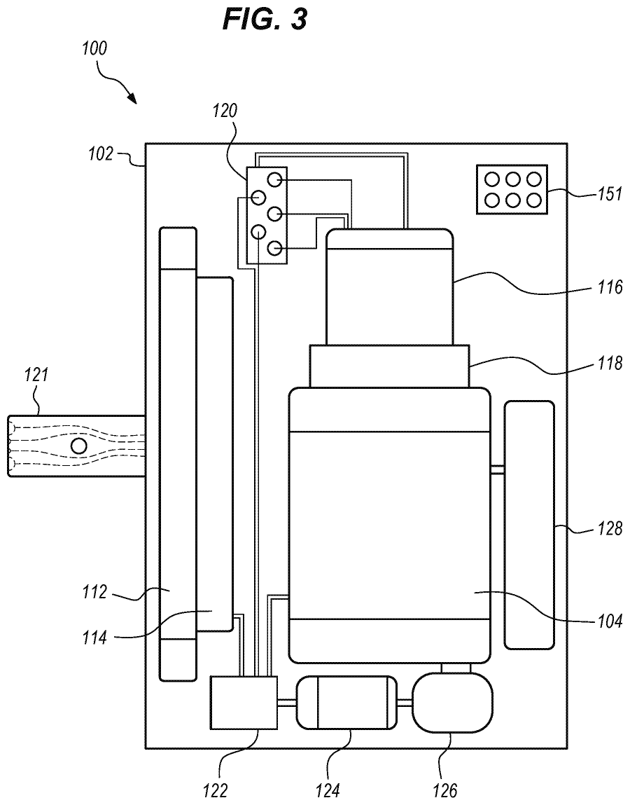

As best seen in FIG. 3, the removably attachable vehicle battery charger 100 comprises a combustion engine 104 (e.g., a high efficiency diesel engine or a small gas engine) configured to charge batteries of the electric vehicle 108. The housing 102 may comprise a radiator 112, a cooling fan 114, an engine starter and generator motor 116, a gear box 118 configured to mesh with the engine 104 and the motor 116, and a rectifier 120 (or controller) for converting alternating current (AC) produced by the motor 116 (when it is being driven by the engine 104) to direct current (DC) for charging the batteries of the electric car 108. For example, power would be supplied to the motor 116, which then starts the engine 104. With the engine 104 started, the engine 104 may then drive the motor 116 to generate AC power. This removes the need for an alternator, which saves space and allows for a more compact design. However, it will be appreciated that a configuration utilizing an alternator is contemplated herein and does not depart herefrom. An optional gearbox 118 may be used to help the motor 116 match the RPM/torque of the engine 118 for better power output. The AC power is then converted to DC power using a rectifier 120 and the DC power is then provided to the vehicle battery charging system via a plurality of wires 121 to charge the batteries of the electric vehicle 108.

In some embodiments, the removably attachable vehicle battery charger 100 comprises a charge controller 122 configured to monitor the status of the vehicle batteries, the status of the engine 104 and motor 116, and is configured to selectively provide power to start the motor 116 or to transmit power from the rectifier 120 to the vehicle batteries. Additionally, the charge controller 122 is configured to monitor temperature, fuel status, and other engine components, as known in the art. In some embodiments, the charge controller 122 may further control a boost motor 124 configured to drive a supercharger 126 for the engine 104. While a boost motor 124 and supercharger 126 is shown, it will be appreciated that a configuration utilizing a turbocharger, as known in the art, may also be used. The housing 102 may further comprise a fuel tank 128 for supplying fuel to the engine 104.

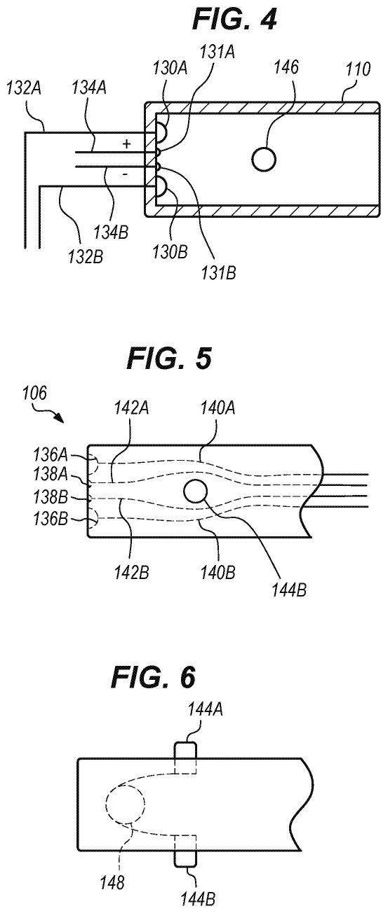

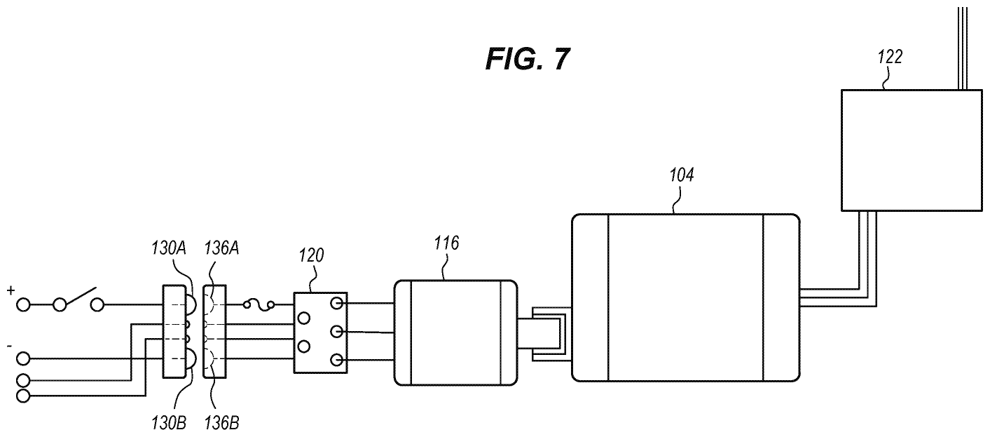

To effectuate the charging of the batteries of the electric vehicle 108, an electrical connection is made in the receiver 110 with the tongue 106. For example, referring to FIGS. 4-7, a hitch receiver 110 comprises one or more high-voltage electrical contacts 130A-B wired to the battery charging system of the electric vehicle 108 and one or more signal contacts 131A-B. In some examples, the wiring may include high-voltage power wires 132A-B and signal wires 134A-B that allow a controller (e.g., controller 122) to determine when to send power through the high-voltage wires 132A-B. For example, the tongue 106 comprises high-voltage electrical contacts 136A-B, signal contacts 138A-B, with high-voltage wires 140A-B and signal wires 142A-B leading to the controller 122 and/or the rectifier 120. As a result, when the tongue 106 is inserted into the receiver 110, the high-voltage contacts 130A-B and 136A-B and the signal contacts 131A-B and 138A-B all make electrical contact with one another, respectively. The controller 122 detects that the connection is complete via the signal contacts 138A-B contacting signal contacts 131A-B. As a result, the controller 122 transmits DC power through the high-voltage wires 140A-B to the high-voltage contacts 136A-B, where the DC power is transmitted to high-voltage contacts 130A-B of the receiver 110 and to the vehicle battery charging system via the high-voltage wires 132A-B. Using signal contacts 138A-B ensures that the high-voltage contacts 136A-B are not “live” or “hot” when not coupled to the receiver 110, preventing shock or other danger to a user. FIG. 7 illustrates an example wiring diagram of the removably attachable vehicle battery charger 100.

The tongue 106 may comprise one or more locking buttons 144A-B for mating with hitch pin slot 146 of the receiver 110. The locking buttons 144A-B may be spring-actuated using a spring 148. While spring-actuated locking buttons 144A-B are described and shown for preventing unwanted withdrawal of the tongue 106 from the receiver 110, other methods may be used, such as locking pins, cotter pins, or other known methods in the hitch art.

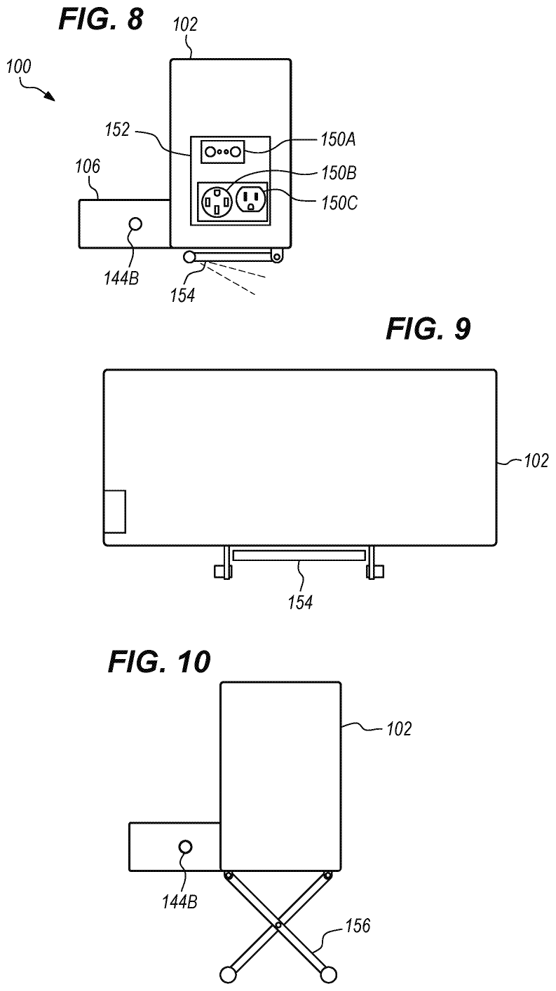

Referring to FIGS. 8-9, the removably attachable vehicle battery charger 100 may comprise one or more power outlets 150A-C. Each outlet 150A-C may comprise a cover, or a door/access panel 152 may cover the outlets 150A-C when not in use. It will be appreciated that the outlets may vary in output from each other, such as 110V, 220V, etc. To accomplish this, the removably attachable vehicle battery charger 100 may comprise a variable frequency drive (VFD) 151 (FIG. 3) to allow for changes in phase voltages and/or frequency, according to a user's needs.

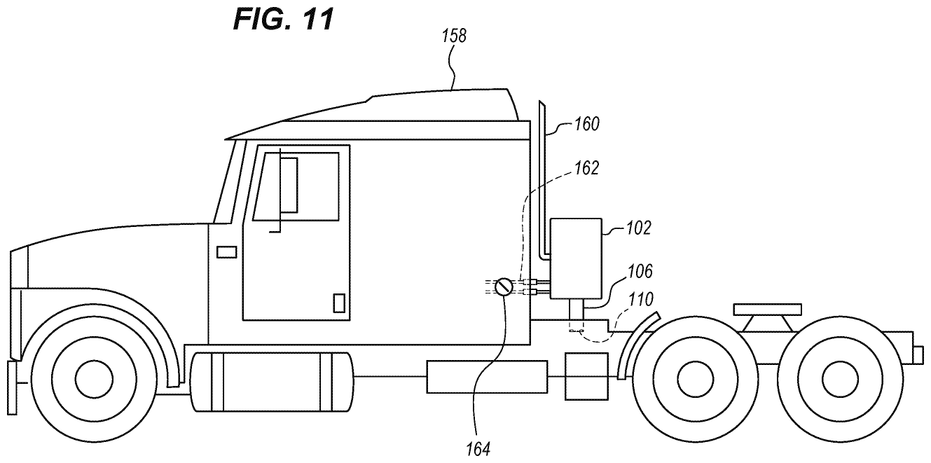

Additionally, the removably attachable vehicle battery charger 100 may comprise a dolly bracket 154 or a wheel system, such as scissor lift 156 (FIG. 10), to aid in lifting the removably attachable vehicle battery charger 100 for coupling to an electric vehicle 108. While shown as coupling to an electric car, it will be appreciated that a truck or other electric vehicle may be used.

Further, referring to FIG. 11, the removably attachable vehicle battery charger 100 may be coupled to an electric commercial truck 158 (e.g., tractor-trailer truck) for increased range. The tongue 106 may be configured to extend from the housing 102 in any direction to best suit the application. As shown, the tongue 106 may be received into a vertical receiver 110. If desired, the exhaust 160 from the engine 104 may be configured in a stack-like configuration, typical of commercial diesel trucks. Further, one or more water hoses 162 may be coupled to the removably attachable vehicle battery charger 100 using a quick-connect or other coupler known in the art. Water flow through the hose 162 may be controlled via the controller 122 controlling an electric valve 164. The water may be used to cool the engine 104 or to supply heated water to the batteries of the electric commercial truck 158, which is beneficial in cold climates.

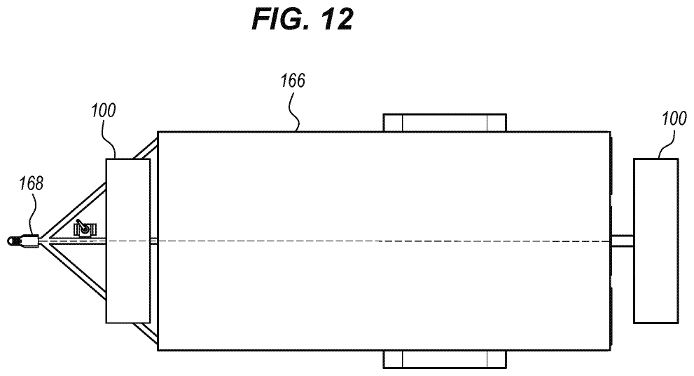

FIG. 12 illustrates a trailer 166 comprising a removably attachable vehicle battery charger 100. The removably attachable vehicle battery charger 100 may be located on the front of the trailer near the trailer tongue 168, at the rear, or at any other convenient location. The removably attachable vehicle battery charger 100 may be wired to supply power to the trailer components (e.g., lights, heater, A/C, radio, etc.) and may further be wired to the electric vehicle pulling the trailer 166 via the trailer tongue 168. In other words, the trailer tongue 168 may be configured as the tongue 106 previously described herein. As a result, the removably attachable vehicle battery charger 100 may provide power to the trailer, to the electric vehicle pulling the vehicle, or both.

The advantages of this will be readily appreciated. For example, electric vehicle range is significantly diminished when pulling a load such as a trailer. By using the removably attachable vehicle battery charger 100, as the vehicle batteries near depletion (or at a level as determined by a user), the controller 122 may initiate the engine 104 to supply power to charge the vehicle batteries. Additionally, the engine 104 may run to power components of the trailer 166 or items therein, or to charge one or more batteries in the trailer 166. Because the engine 104 uses fuel, a user may recharge the batteries of the electric vehicle even when no grid electric power supply is available, such as in the mountains. This allows a user to pull trailers with less stops to charge and allows users to recharge in areas that were heretofore unavailable for charging. It will be appreciated that the removably attachable vehicle battery charger 100 may be removably attachable from the trailer 168 in the same manner as described above in relation to an electric vehicle 108. Accordingly, the removably attachable vehicle battery charger 100 may be directly coupled to the receiver 110 of a vehicle 108 when desired, or may be coupled to the trailer 166 when a user desires to the pull the trailer 166, with the trailer tongue 168 comprising the same connections as the tongue 106. However, it will be appreciated that, in some embodiments, the removably attachable vehicle battery charger 100 need not be removable from the trailer 166, but may be integrated therewith.

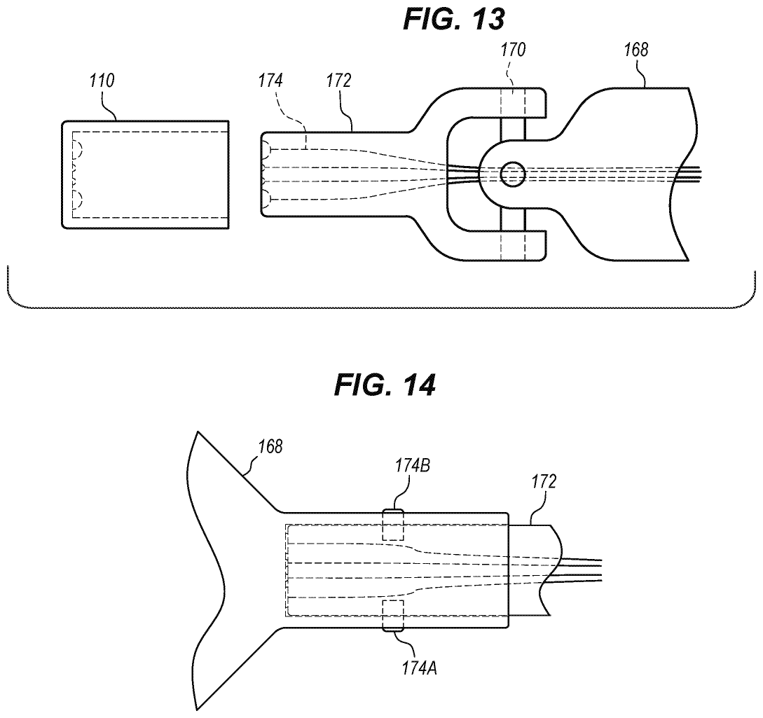

Referring to FIG. 13, to ensure that the trailer 166 can move freely without damaging the receiver 110 of the electric vehicle 108, a universal joint 170 (U-joint) may be interposed between the trailer tongue 168 and the receiver 110. An adapter tongue 172 may then be inserted into the receiver 110, the adapter tongue 172 having the same configuration at the tongue 106 described earlier herein. As shown, a cable 174 comprising the wires (e.g., 140A-B and 142A-B) may pass from the adapter tongue 172, through the U-joint 170, and into the trailer tongue 168 and to the removably attachable vehicle battery charger 100 located on the trailer 166. The U-joint allows the trailer to move in response to road conditions without comprising the wiring connections or the adapter tongue 172 in the receiver 110. Referring to FIG. 14, the adapter tongue 172 may couple to a trailer tongue 168 and be secured thereto using one or more securing pins 174A-B.

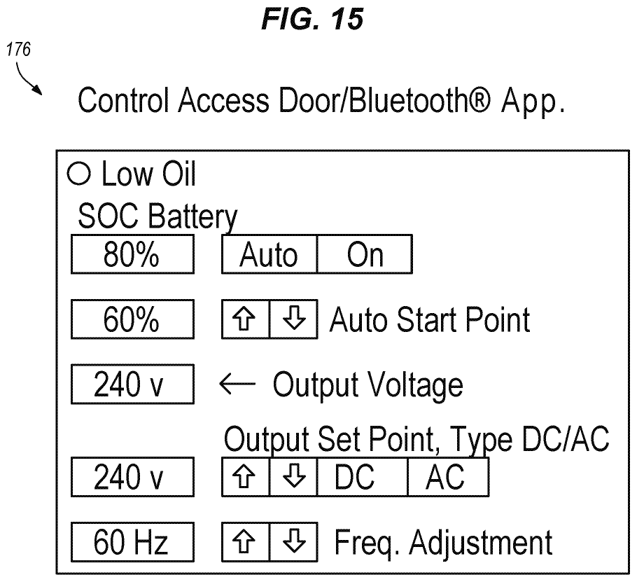

Referring to FIG. 15, a user interface 176 allows for customization of the operating conditions of the removably attachable vehicle battery charger 100. The user interface 176 may be on the removably attachable vehicle battery charger 100 itself, such as a touch screen, or may be an application that is configured to launch on a smartphone, tablet, or computer using wired or wireless protocols (e.g., Bluetooth®). As shown, the user interface may comprise oil indicators, state of charge indicators, voltage indicators, among others. The indicators may be lights or readouts. In addition, a user may adjust or set functions, such as changing the output voltage (e.g., 110V or 220V), changing output type (e.g., AC or DC), setting an automatic start point (such as when the state of charge of the vehicle batteries drop below the set threshold), among other features. The user interface interacts with the controller 122, which thereby controls the components of the removably attachable vehicle battery charger 100.

In some embodiments, the engine 104 may charge a battery pack in the housing 102 as well as the batteries of the electric vehicle 108.

A method of extending the range of an electric vehicle comprises coupling a removably attachable battery charger 100 to the electric vehicle, the removably attachable battery charger 100 comprising at least a combustion engine 104, a motor 116 for generating AC power. In some embodiments, the removably attachable battery charger 100 may comprise a rectifier 120 (or other converter) for converting AC to DC. However, it will be appreciated that in some embodiments, AC power is provided to the electric vehicle with the vehicle comprising a converter to convert the AC power to DC power for charging the batteries. In either scenario, it will be appreciated that the removably attachable battery charger 100 may supply power to charge the batteries of the electric vehicle at any location, and while the electric vehicle is parked or in motion—which the prior art is incapable of doing. In some embodiments, the controller 122 may be programmed to override any vehicle programming that prohibits the vehicle from being in motion while charging. In other embodiments, the wiring to the receiver 110 may bypass the vehicle battery management system and may be coupled to the batteries separate therefrom, so as to be capable of charging while driving without overriding vehicle programming. Additionally, using a user interface 176, a user may program the operation of the removably attachable battery charger 100. For example, a user may determine the threshold of the state of charge (e.g., 50%, 10%, etc.) of the vehicle batteries before initiating the engine 104 to charge the batteries, among other features.

It will be appreciated that the removably attachable battery charger 100 may extend the life of the electric vehicle's batteries by up to 50% and eliminates need for supercharging. It will further be appreciated that the removably attachable battery charger may charge an electric vehicle or a home if the power grid is down by using the additional ports/outlets 150A-C as shown in FIG. 8. When using the removably attachable vehicle battery charger 100, the battery size and/or number used in an electric vehicle 108 may be reduced, which can save a car manufacturer money and, in return, save a user money. In other words, typical daily driving around a city does not require the size and number of batteries currently in electric vehicles, but are there for longer trips and usage. However, with the removably attachable vehicle battery charger 100, an electric vehicle may have few or smaller batteries that are sufficient for everyday use, and then a user may couple the removably attachable vehicle battery charger 100 to the electric vehicle when extended driving or towing is required. By utilizing fewer batteries, money is saved in not only materials, but because the electric vehicle is lighter, it is also more efficient, which reduces costs associated with charging.

The removably attachable vehicle battery charger 100, in some embodiments, may comprise a battery management system (e.g., controller 122) to communicate with a battery system of the electric vehicle 108. The battery management system may communicate with the vehicle's battery system via a wired connection (e.g., the charging components and the electrical components) and/or a wireless connection. It will be appreciated that a user may control and monitor the removably attachable vehicle battery charger 100 via a user input device, such as a proprietary panel, remote control device, or a smartphone, tablet, or computer.

As described earlier, in some embodiments, the removably attachable vehicle apparatus 100 may comprise a dolly or legs with casters or wheels, which may assist a user in coupling and decoupling the removably attachable vehicle battery charger 100 from the electric vehicle 108. The dolly or legs may be removable or hinged so as to not interfere with driving when coupled to the electric vehicle 108. In some embodiments, the legs may be configured as a scissor-lift 156.

The battery management system may take different forms, such as electronic control modules (ECMs), personal computers, laptop computers, tablets, handheld devices (e.g., mobile phones, PDAs, pagers), microprocessor-based or programmable consumer electronics, minicomputers, multi-processor systems, network PCs, distributed computing systems, datacenters, message centers, routers, switches, and even devices that conventionally have not been considered a computing system, such as wearables (e.g., glasses, head-mounted displays). The battery management system may also be a distributed system that includes one or more connected computing components/devices that are in communication. Accordingly, the battery management system may be embodied in any form and is not limited to any particular embodiment explicitly shown herein.

In its most basic configuration, the battery management system includes at least one hardware processing unit (aka a “processor”), input/output (I/O) interfaces, and storage.

The storage may be physical system memory, which may be volatile, non-volatile, or some combination of the two. The term “memory” may also be used herein to refer to non-volatile mass storage such as physical storage media. If the battery management system is distributed, the processing, memory, and/or storage capability may be distributed as well. As used herein, the term “executable module,” “executable component,” or even “component” can refer to software objects, routines, or methods that may be executed on the battery management system. The different components, modules, engines, and services described herein may be implemented as objects or processors that execute on the battery management system (e.g., as separate threads).

Computer storage media are hardware storage devices, such as RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

The disclosed embodiments may comprise or utilize a special-purpose or general-purpose computer including computer hardware, such as, for example, one or more processors (such the hardware processing unit, which may include one or more central processing units (CPUs), graphics processing units (GPUs) or other processing units) and system memory (such as storage).

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code.

While not all computing systems require a user interface, in some embodiments, a battery management system includes, as part of the I/O interfaces, a user interface for use in communicating information to/from a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, controllers, projections, holograms, cameras, keyboards, stylus, mouse, or other pointer input, sensors of any type, and so forth. The battery management system may perform certain functions in response to detecting certain user input.

Further, the battery management system may also include communication channels allowing the battery management system to be in wireless (e.g., Bluetooth®, Wi-Fi®, satellite, infrared, etc.) or wired communication with the electric vehicle's battery management and computer system, networks, and/or other remote systems/devices. Remote systems/devices may be configured to perform any of the processing described with regard to battery management system. By way of example, a remote system may include an administrative system that defines operation constraints for the removably attachable vehicle battery charger and/or issues commands to selectively deactivate the engine and/or motor that is in communication with the battery management system.

In some embodiments, the battery management system includes computer-executable instructions (e.g., stored on storage) that enable the battery management system (e.g., by one or more processors executing the computer-executable instructions) to selectively activate or deactivate any portion of the battery management system, such as the engine and/or motor. In some instances, the battery management system selectively deactivates or activates at least one component of the system in response to a triggering event. As one example, the triggering event includes detecting that the electric vehicle's battery has reach a predetermined threshold (e.g., 50% depth of discharge) and to initiate charging via the removably attachable vehicle battery charger 100.

Typical lithium batteries found in electric vehicles are limited to a certain number of cycles before end of life. For example, some lithium batteries last 1600 cycles. A cycle occurs when a battery is discharged and then fully charged. To prolong the life of the electric vehicle battery, in some embodiments, the removably attachable vehicle battery charger 100 begins charging the electric vehicle's battery when it reaches 50% depth of discharge (DOD). Accordingly, full cycles of the battery are eliminated, thereby increasing the life of the electric vehicle's battery. In addition, the removably attachable vehicle battery charger 100 may increase life expectancy of batteries.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A removably attachable vehicle battery charger, comprising:
a housing;
a combustion engine;
an electric motor coupled to the combustion engine, wherein the electric motor is configured to start the combustion engine and then be driven by the combustion engine to generate alternating current;
a rectifier configured to convert the alternating current to direct current; and
a tongue extending from the housing and configured to insert into a receiver of an electric vehicle, the tongue comprising a plurality of electrical contacts and wires for transmitting the direct current to charge batteries of the electric vehicle.

2. The removably attachable vehicle battery charger of claim 1, further comprising a charge controller.

3. The removably attachable vehicle battery charger of claim 1, further comprising a boost motor and a supercharger.

4. The removably attachable vehicle battery charger of claim 1, further comprising a fuel tank.

5. The removably attachable vehicle battery charger of claim 1, further comprising a gear box coupling the combustion engine to the electric motor.

6. The removably attachable vehicle battery charger of claim 1, further comprising a radiator and cooling fan.

7. The removably attachable vehicle battery charger of claim 1, further comprising exhaust configured as stacks.

8. The removably attachable vehicle battery charger of claim 1, further comprising water hoses configured to couple to the electric vehicle to provide water thereto.

9. The removably attachable vehicle battery charger of claim 1, further comprising a variable frequency drive.

10. The removably attachable vehicle battery charger of claim 1, further comprising one or more electrical outlets on the housing configured to supply alternating current, direct current, or both.

11. The removably attachable vehicle battery charger of claim 1, further comprising a scissor-lift.

12. The removably attachable vehicle battery charger of claim 1, further comprising a dolly bracket coupled to the bottom of the housing.

13. A removably attachable vehicle battery charger, comprising:
a housing;
a combustion engine;
an electric motor coupled to the combustion engine;
a rectifier configured to convert alternating current received from the electric motor to direct current; and
a tongue extending from the housing and configured to insert into a receiver, the tongue comprising a plurality of electrical contacts and wires for transmitting the direct current.

14. The removably attachable vehicle battery charger of claim 13, wherein the receiver is located on a trailer.

15. The removably attachable vehicle battery charger of claim 13, wherein the receiver is located on an electric vehicle.

16. The removably attachable vehicle battery charger of claim 13, further comprising a boost motor and a supercharger.

17. The removably attachable vehicle battery charger of claim 13, further comprising a gear box coupling the combustion engine to the electric motor.

18. The removably attachable vehicle battery charger of claim 13, further comprising a variable frequency drive.

19. The removably attachable vehicle battery charger of claim 13, further comprising one or more electrical outlets on the housing configured to supply alternating current, direct current, or both.

20. A method of extending the range of an electric vehicle using the removably attachable vehicle battery charger of claim 13, wherein the method comprises:
inserting the tongue into the receiver, the electrical contacts of the tongue making an electrical connection with a plurality of electrical contacts in the receiver;
starting the combustion engine using the electric motor;
driving the electric motor using the combustion engine, the electric motor generating alternating current;
converting the alternating current to direct current using a rectifier; and
supplying the direct current to the plurality of electrical contacts within the tongue, the direct current flowing to the electric vehicle to charge one or more batteries via the plurality of electrical contacts in the receiver.
